(19) United States
(12) Patent Application Publication
(10) Pub. No.: US 2005/0117323 A1
(43) Pub. Date: Jun. 2, 2005

(54) Backlight module of liquid crystal display

(75) Inventor: David King, Shin-Dian city (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: LITEMAX Electronic Inc., Taipei County (TW)

(21) Appl. No.: 10/987,251

(22) Filed: Nov. 12, 2004

(30) Foreign Application Priority Data
Nov. 14, 2003 (TW) 092220271

(51) Int. Cl. F21V 7/04; A47G 1/17

(52) U.S. Cl. 362/31

(57) ABSTRACT

A backlight module of a liquid crystal display is provided. The backlight module of a liquid crystal display includes a propping body having at least one propping channel, and at least one light tube set on the propping channel. The light tube is uniformly supported by the propping channel, and it won't be bent or broken so easily by the external force.

### FIELD OF THE INVENTION

The present invention relates to a backlight module, and more particularly to a backlight module for a liquid crystal display.

### BACKGROUND OF THE INVENTION

Please refer to FIG. 1, which is a cross-section view showing a liquid crystal display with a backlight module according to the prior art. The light tube 1 is set at the side of the liquid crystal display 10 and is wrapped in the groove 30 of the reflecting shell body 3. The reflecting shell body 3 is connected to the lightguide 2 so that the light emitted from the light tube 1 is directly transmitted into the lightguide 2. Since the light would diffuse in the lightguide 2, the light would be transmitted through the lightguide 2 and a backlight transmission is formed accordingly.

The backlight module of the liquid crystal display shown in FIG. 1 is usually called as the edgelight module. Since the light tube 1 is set at the side of the liquid crystal display 10, the edgelight module has the advantage of the decreasing thicknesses of displays. On the other hand, owing to such a design as setting the light tube 1 aside, there still exists a disadvantage, i.e. the farther the distance away from the light tube 1 is, the fewer the light amount is. This uneven light amount distribution may be balanced at certain extent by sticking a diffuser between the liquid crystal display device 100 and the lightguide 2 and near the reflecting shell body 3. The diffuser is not shown in FIG. 1, but it can be applied in the prior techniques for equalizing the light amount at different areas of the liquid crystal display 10. However, when the size of the liquid crystal display 10 is enlarged to a certain extent, the even light amount distribution, particularly that on the central portion of the liquid crystal display 10, is hard to be achieved by merely using the diffuser. Therefore, another backlight module is needed.

Please refer to FIG. 2, which is a schematic view showing another liquid crystal display with a backlight module according to the prior art. Such backlight module of the liquid crystal display is called the direct-light module, which is capable of overcoming the defect of the edgelight module as described above. The concept of direct-light module is that the light tubes 1 are put at the back of the liquid crystal display device 100 (as shown in FIG. 1). In FIG. 2, the backlight module includes the frame 4. The display region 40 is defined from the frame 4 for placing a liquid crystal display device 100. Further, plural light tubes 1 are put in the frame 4. Accordingly, the brightness of the area located directly on the top of the light tube 1 is higher than that of the area located on the top between two adjacent light tubes 1. The brightness of the area located on the top between two adjacent light tubes 1 can be easily improved by employing the diffuser as mentioned above. Under such a direct-backlight module, the distance between the light tube and the liquid crystal display device 100 (as shown in FIG. 1) is not bound to be increased when the liquid crystal display 10 is enlarged. As the liquid crystal display 10 is enlarged, the brightness and distance between light tubes 1 can be kept unchanged by appropriately increasing the number of the light tubes 1 or the length of the light tubes 1.

However, as the liquid crystal display 10 is enlarged, the lengths of the light tubes become longer but only the two ends of the light tube 1 are propped by the frame 4. If the light tubes 1 with long-lengths are not well supported, they will be fragile against the external forces due that they have features of weak rigiditys and are made of glass. For example, light tubes in the horizontal depositions are easily bent under the gravity, and thus the original light-emitting positions will be changed. Besides, after being affected by the gravity for a long time, the material of the light tube 1 will become more fragile. In another defect of the light tube 1 with long-length, since only the two ends thereof are secured on the frame 4, the light tube 1 itself vibrates quite easily in the central portion upon any vibration from the frame 4. Thus the light tubes 1 will be broken due to the frequent vibration in the long run. Therefore, a new backlight module of a liquid crystal display in the industries being capable for uniformly propping the light tubes is desirous.

### SUMMARY OF THE INVENTION

The present invention provides a backlight module of a liquid crystal display including a propping body having at least one propping channel, and at least one light tube set on the propping channel, wherein the light tube is uniformly supported by the propping channel.

Preferably, the propping body is a solid body.

Preferably, the propping body further includes a reflector and a diffuser positioned opposite to each other.

Preferably, the propping body is a shell body, and the propping channel is a tube body.

Preferably, the propping body further includes a propping rib set therein and perpendicular to the propping channel.

Preferably, the propping body further includes a placing space formed therein for reserving a fluid so as to facilitate a heat convection.

In accordance with one aspect of the present invention, a backlight module of a liquid crystal display is provided. The backlight module includes a propping body having at least one propping groove across the propping body, and at least one light tube in the propping groove.

Preferably, the propping body is a solid body.

Preferably, the propping body further includes a reflector and a diffuser positioned opposite to each other.

Preferably, the propping body is a shell body, and the propping groove is an open tube body.

Preferably, the propping body further includes a propping rib set therein and perpendicular to the propping groove.

Preferably, the propping body further includes a placing space formed therein for reserving a fluid so as to facilitate a heat convection.

Preferably, the propping body further includes a propping rib set therein and perpendicular to the open tube body, a placing space formed therein for reserving a fluid so as to facilitate a heat convection, and the propping rib further includes at least one communication hole mounted thereon for a communication of the fluid.

In accordance with another aspect of the present invention, a liquid crystal display with a backlight module includes a liquid crystal display device set on the backlight module. The backlight module further includes a propping body having at least one propping channel, and at least one light tube set in the propping channel, wherein the light tube is uniformly supported by the propping channel.

Preferably, the propping body is a solid body, and the propping channel pierces through the solid body.

Preferably, the propping body is a shell body, and the propping channel is a tube body.

Preferably, the propping body is a solid body, and the propping channel has a ditch shape.

Preferably, the propping body is a shell body, and the propping channel is a bending shell structure.

Preferably, the propping body further includes a reflector and a diffuser positioned opposite to each other.

Preferably, the propping body further includes a placing space formed therein for reserving a fluid so as to facilitate a heat convection.

In accordance with another aspect of the present invention, a backlight module of a liquid crystal display includes a propping device for uniformly propping a light tube.

The foregoing and other features and advantages of the present invention will be more clearly understood through the following descriptions with reference to the drawings, in which:

### BRIEF DESCRIPTION OF THE DRAWINGS

FIG. 1 is a cross-section view showing a liquid crystal display with a backlight module according to the prior art;

FIG. 2 is a schematic view showing another liquid crystal display with a backlight module according to the prior art;

FIG. 3 shows a three-dimensional structure of propping body according to a preferred embodiment of the present invention;

FIG. 4 is a side view of the propping body in FIG. 3;

FIG. 5 is a side view showing a propping body according to another preferred embodiment of the present invention;

FIG. 6 shows a three-dimensional structure of a portion of the propping body in FIG. 5;

FIG. 7 shows the propping body according to another preferred embodiment of the present invention;

FIG. 8 is a cross-section view of the propping body according to another preferred embodiment of the present invention; and

FIG. 9 is a schematic view showing an employment according to a preferred embodiment of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed. One purpose of the present invention is to provide a backlight module of a liquid crystal display. In the backlight module, the light tube is uniformly supported and won't be bent easily. The present invention will now be described more specifically with reference to the following embodiments.

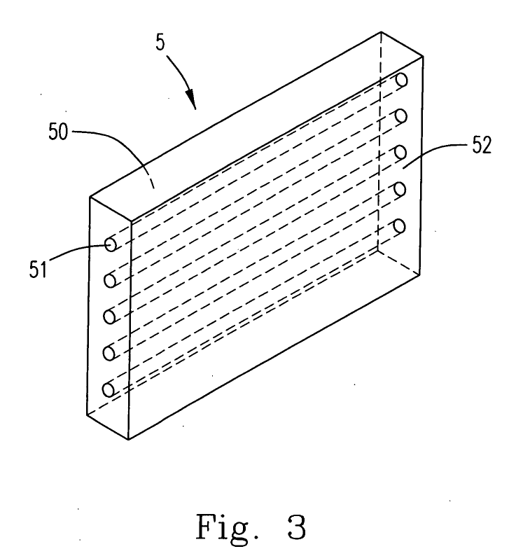

Please refer to FIG. 3, which shows a three-dimensional structure of propping body according to a preferred embodiment of the present invention. The backlight module of the present invention includes the propping body 5. The propping channels 51 are excavated on the propping body 5. The light tube (not shown) is put in the propping channel 51. The propping channel 51 is a long, smooth, and even channel. Thus the light tube can be uniformly supported in the inner part of the propping channel 51, and the light tube is not easy to be bent by gravity. As an external force is applied on the liquid crystal display (not shown), the external force can be evenly or uniformly supported or passed through. Under such a designation, the vibration caused by the external force would not be focused on the central portion of the light tube. Thus, the opportunities of being bent or broken for the light tube would be far reduced. Therefore, the technique of the present invention is superior to that of the prior art.

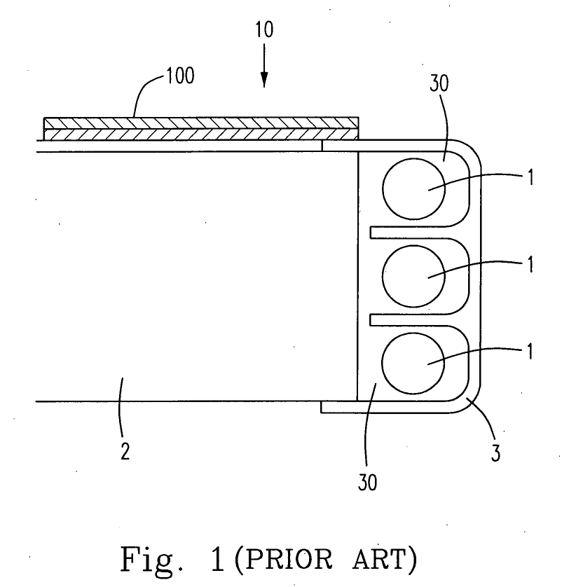

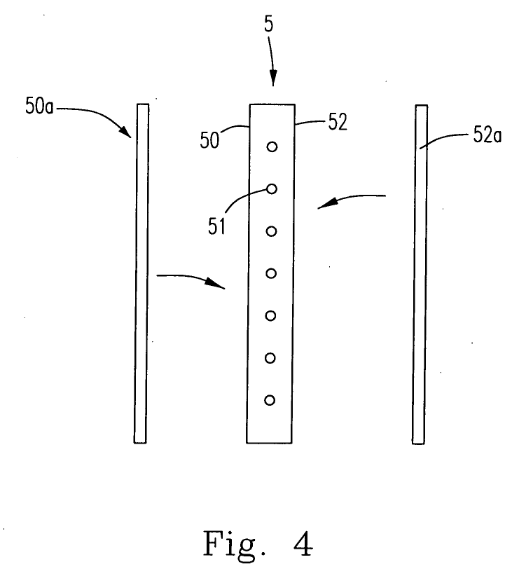

Please refer to FIG. 4, which is a side view of the propping body in FIG. 3. The propping body 5 has several propping channels 51, the first face 50 and the second face 52. The reflector 50a is attached on the first face 50, and the diffuser 52a is attached on the second face 52. The light is reflected by the reflector 50a and further transmitted to the diffuser 52a so that the light amount would be increased. In addition, the propping body 5 can be a solid body, and can be seen as a transparent or semi-transparent body. The material for the solid body 5 can be the same as that for the lightguide 2 (shown in FIG. 1) or that for the diffuser 52a.

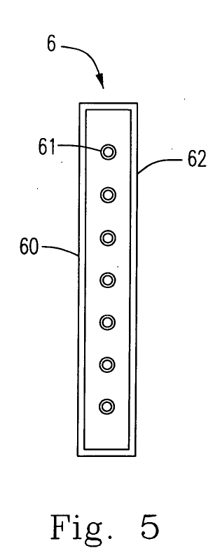

Please refer to FIG. 5, which is a side view showing a propping body according to another preferred embodiment of the present invention. In the preferred embodiment, the propping body 6 is a shell body, and the propping channel 61 is a tube body. The shell body is hollow so that the weight of shell body is lighter than a solid one. The light tube (not shown) is put in the propping channel 61. The propping channel 61 is a long, smooth, and even tube. Thus the light tube can be uniformly supported in the inner part of the propping channel 61, and the light tube is not easy to be bent or broken.

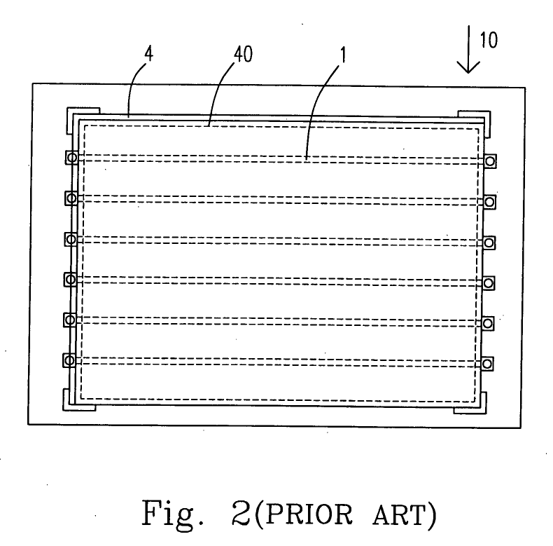

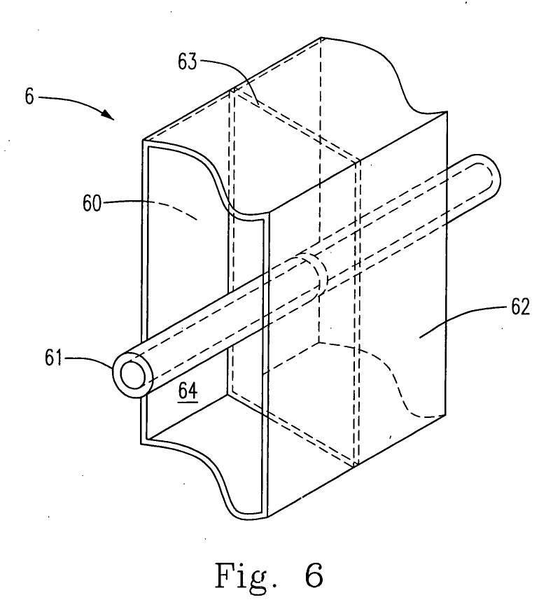

Please refer to FIG. 6, which shows a three-dimensional structure of a portion of the propping body in FIG. 5. When the liquid crystal display is enlarged, the size of the backlight module is also increased. Thus the propping channel 61 will be bent by gravity, or it will be vibrated back and forth upon the external force. Accordingly, the propping rib 63 is set to prop the propping channel 61 between the propping body 6 and the propping channel 61. This overcomes the defects of prior technique shown in FIG. 2. In addition, the propping body 6 further includes the first face 60 and the second face 62. A reflector can be attached on the first face 60, and a diffuser can be attached on the second face 62 if necessary. In the general condition, the positions of the reflector and the diffuser on the propping body 6 can be exchanged.

When the module of the present invention is used, the light tubes give out heat. According to the embodiment shown in FIG. 3, the heat produced from the light tube is conducted to the environment via the solid propping body 5. However, compared to the embodiments in FIGS. 5 and 6, the propping body 6 is a shell body so that there is a placing space 64 in the hollow structure. The heat is conducted from the light tube to the propping body 6 via the propping channel 61 and the propping rib 63. Generally, the fluid existed in the placing space 64 is air. When the propping channel 61 is directly heated by the light tube, the air in the propping channel 61 is indirectly heated and thus the heat convection occurs. Finally, the heat is conducted to the propping body 6 and would be dissipated. Moreover, the air is a mixture with a low density so that the heat convection is poor. A better efficiency can be achieved by filling a single gas, such as helium and nitrogen. Of course, a heat convection device of prior technique can be also applied in the propping body 6. Specifically, a liquid is also preferred to filled in the placing space 64, because it still has the character of fluidity and it has better heat convection in several times than that of the gas upon its compact density.

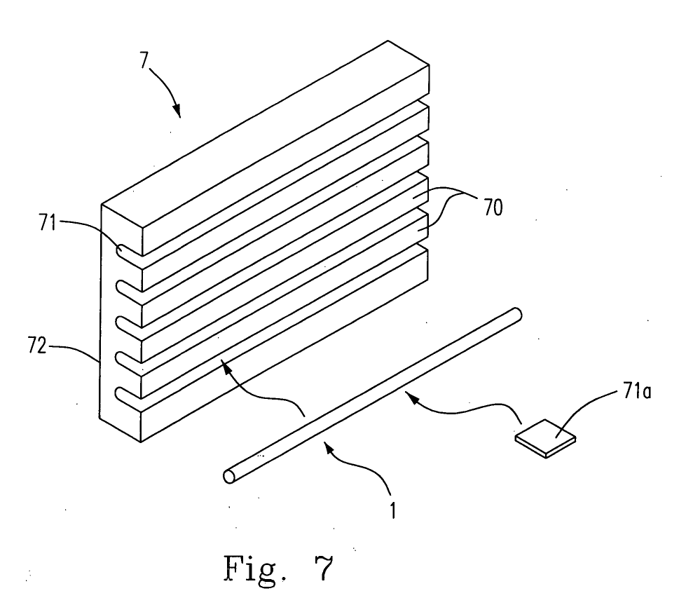

Please refer to FIG. 7, which shows the propping body according to another preferred embodiment of the present invention. The propping grooves 71 are excavated on the propping body 7. The light tube 1 is put in the propping groove 71. Compared to the embodiment show in FIG. 3, the propping groove 71 is a simple structure excavated on the surface of the propping body 7. The propping channels 51 in FIG. 3 are excavated on the solid body of the propping body 5. When the propping body 5 is enlarged, the drilling of the propping channels 51 becomes harder, and it is not easy to keep straightness and the surface smooth of the propping channels 51 constant. However, the defect can be overcome. According to the embodiment in FIG. 7, the side of the propping groove 71 is exposed to the outside of the propping body 7. The propping channels 71 are easily made in the manufacturing process, and the precise machine or highly manufacturing techniques are not necessary. In addition, the light tube 1 is put in the propping groove 71. In order to avoid the rolling of the light tube 1, the light tube 1 is adhered with glue and immobilized with a chock 71a. Furthermore, the propping body 7 further includes the first face 70 and the second face 72. A reflector is attached on the first face 70, and a diffuser is attached on the second face 72, if necessary. The function of the reflector and the diffuser has been described above in the specification, therefore we won't mention them again.

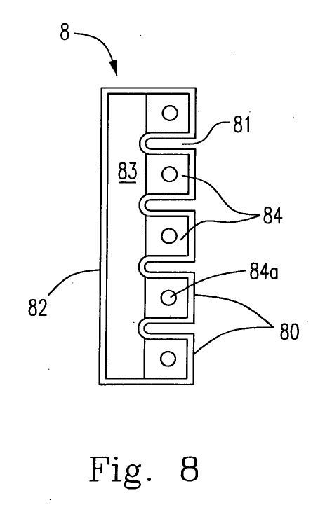

Please refer to FIG. 8, which is a cross-section view of the propping body according to another preferred embodiment of the present invention. The propping body 8 is a shell body, and the propping groove 81 is an open tube body. FIG. 8 is similar to FIG. 7, but the propping body 8 is a hallow shell body, not a solid body. In the propping body 8, the propping rib 84 is set between the propping rib 84 and the propping body 8. Similarly, the placing space 83 is formed in the propping body 8. The fluids, such as gas and liquid, can be filled in the placing space 83 for heat dissipating, wherein the gas can be air, helium, or nitrogen. Moreover, when the propping rib 84 is set perpendicularly to the propping groove 81, the communication hole 84a is excavated to enhance the heat convection. Furthermore, the propping body 8 further includes the first face 80 and the second face 82. A reflector is attached on the first face 80, and a diffuser is attached on the second face 82, if necessary. Generally, the positions of the reflector and the diffuser on the propping body 8 can be exchanged.

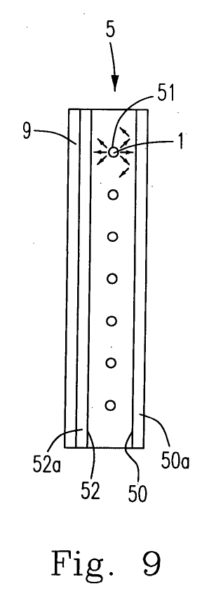

Please refer to FIG. 9, which is a schematic view showing an employment according to a preferred embodiment of the present invention. The employment is able to be applied to the embodiments of FIGS. 3 and 4, and to other embodiments of the present invention. In the propping body 5, the light tube 1 is put on the excavated propping channels 51. The reflector 50a is attached on the first face 50, and the diffuser 52a is attached on the second face 52. Some of the light emitted from the light tube 1 is directly transmitted to the diffuser 52a, and some is reflected by the reflector 50a and further transmitted to the diffuser 52a. Therefore, the light amount displayed on the liquid crystal display device 9 is increased.

From the above description and illustration, the present invention provides a backlight module of a liquid crystal display with a propping body so as to effectively support the light tube. Specifically, an even and smooth propping channel is used in the backlight module. Therefore, the light tube in propping channel is uniformly supported and won't be bent or broken so easily.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. A backlight module of a liquid crystal display, comprising:
a propping body having at least one propping channel; and
at least one light tube set on said propping channel, wherein said light tube is uniformly supported by said propping channel.

2. The backlight module according to claim 1, wherein said propping body is a solid body.

3. The backlight module according to claim 1, wherein said propping body further comprises a reflector and a diffuser positioned opposite to each other.

4. The backlight module according to claim 4, wherein said propping body is a shell body, and said propping channel is a tube body.

5. The backlight module according to claim 1, wherein said propping body further comprises a propping rib set therein and perpendicular to said propping channel.

6. The backlight module according to claim 4, wherein said propping body further comprises a placing space formed therein for reserving a fluid so as to facilitate a heat convection.

7. A backlight module of a liquid crystal display, comprising:
a propping body having at least one propping groove across said propping body; and
at least one light tube in said propping groove.

8. The backlight module according to claim 7, wherein said propping body is a solid body.

9. The backlight module according to claim 7, wherein said propping body further comprises a reflector and a diffuser positioned opposite to each other.

10. The backlight module according to claim 7, wherein said propping body is a shell body, and said propping groove is an open tube body.

11. The backlight module according to claim 10, wherein said propping body further comprises a propping rib set therein and perpendicular to said propping groove.

12. The backlight module according to claim 10, wherein said propping body further comprises a placing space formed therein for reserving a fluid so as to facilitate a heat convection.

13. The backlight module according to claim 10, wherein said propping body further comprises a propping rib set therein and perpendicular to said open tube body, a placing space formed therein for reserving a fluid so as to facilitate a heat convection, and said propping rib further comprises at least one communicating hole mounted thereon for a communication of said fluid.

14. A liquid crystal display with a backlight module, comprising:
a liquid crystal display device set on said backlight module, wherein said backlight module further comprises:
a propping body having at least one propping channel; and
at least one light tube set in said propping channel, wherein said light tube is uniformly supported by said propping channel.

15. The backlight module according to claim 14, wherein said propping body is a solid body, and said propping channel pierces through said solid body.

16. The backlight module according to claim 14, wherein said propping body is a shell body, and said propping channel is a tube body.

17. The backlight module according to claim 14, wherein said propping body is a solid body, and said propping channel has a ditch shape.

18. The backlight module according to claim 14, wherein said propping body is a shell body, and said propping channel is a bending shell structure.

19. The backlight module according to claim 14, wherein said propping body further comprises a reflector and a diffuser positioned opposite to each other.

20. The backlight module according to claim 14, wherein said propping body further comprises a placing space formed therein for reserving a fluid so as to facilitate a heat convection.

21. A backlight module of a liquid crystal display, comprising:
a propping device for uniformly propping a light tube.
